(19) United States
(12) Patent Application Publication
(10) Pub. No.: US 2014/0207888 A1
(43) Pub. Date: Jul. 24, 2014

(54) INFORMATION PROCESSING METHOD AND DEVICE IN INSTANT MESSAGING

(71) Applicant: TENCENT TECHNOLOGY (SHENZHEN) COMPANY LIMITED, Shenzhen (CN)

(72) Inventor: Zhihao Zheng, Shenzhen (CN)

(73) Assignee: TENCENT TECHNOLOGY (SHENZHEN) COMPANY LIMITED, Shenzhen (CN)

(21) Appl. No.: 14/222,006

(22) Filed: Mar. 21, 2014

Related U.S. Application Data
(63) Continuation of application No. PCT/CN2012/080770, filed on Aug. 30, 2012.

(30) Foreign Application Priority Data
Sep. 30, 2011 (CN) 201110297996.3

(51) Int. Cl. H04L 12/58

(52) U.S. Cl. CPC H04L 51/04
USPC 709/206

(57) ABSTRACT

The present invention discloses an information processing method in instant messaging. The method includes: establishing and recording a binding relationship between an information terminal and an instant messaging account; determining whether the information terminal is currently under a binding state with the instant messaging account according to the blinding relationship recorded when monitoring that the information terminal is to upload data, allowing the information terminal to upload the data if it is determined that the information terminal is under the binding state with the instant messaging account; receiving the data uploaded by the information terminal, providing the uploaded data to another information terminal.

The present invention claims the benefit and priority of Chinese patent application No. 201110297996.3, entitled “Information Processing Method and Device in Instant Messaging” filed on Sep. 30, 2011. The entire disclosure of the above application is incorporated herein by reference.

### FIELD OF THE INVENTION

The present invention relates to internet techniques, and more particularly, to an information processing method and device in instant messaging.

### BACKGROUND OF THE INVENTION

With the development of mobile internet, instant messaging is now broadly used in mobile communications. The instant messaging can implement applications such as transmitting and receiving internet messages instantly.

However, in conventional mobile techniques for the instant messaging, instant messaging applications and information terminals are independent. The information terminals are devices that can be used to input information such as images, characters, audios, videos and so on. The information terminals may be mobile hardware devices, such as webcams, mobile phones, and may be devices that cannot be moved. Since the instant messaging applications and the information terminals are independent, the information terminals cannot achieve interconnection and interworking with the instant messaging applications, and operations such as monitoring cannot be implemented in the information terminals through the instant messaging applications. Thus, it is impossible to achieve autonomy and interconnection for the information terminals.

### SUMMARY OF THE INVENTION

The present invention provides an information processing method and device in instant messaging, so as to implement interconnection and interworking between an information terminal and an instant messaging application.

A technical solution in the present invention includes:

An information processing method in instant messaging includes:
establishing and recording a binding relationship between an information terminal and an instant messaging account;
determining whether the information terminal is currently under a binding state with the instant messaging account according to the blinding relationship recorded when monitoring that the information terminal is to upload data, allowing the information terminal to upload the data if it is determined that the information terminal is under the binding state with the instant messaging account;
receiving the data uploaded by the information terminal, providing the uploaded data to another information terminal.

An information processing device in instant messaging corresponds to at least one instant messaging account, which includes:
a binding module, to establish and record a binding relationship between an information terminal and an instant messaging account;
an uploading module, to determine whether the information terminal is currently under a binding state with the instant messaging account according to the blinding relationship recorded when it is monitored that the information terminal is to upload data, allow the information terminal to upload the data if it is determined that the information terminal is under the binding state with the instant messaging account;
a data sharing module, to receive the data uploaded by the information terminal, provide the uploaded data to another information terminal.

It can be seen from the above technical solution that, in the present invention, the instant messaging account is bound with the information terminal. The data uploaded by the information terminal bound with the instant messaging account is received. And the uploaded data is provided to another information terminal, so as to implement interconnection and interworking between the information terminal and the instant messaging application.

Furthermore, in the present invention, since the instant messaging account is bounded with the information terminal, another instant messaging account can achieve information interacting with the information terminal through the instant messaging account bounded with the information terminal so as to enhance the information interacting.

### BRIEF DESCRIPTION OF DRAWINGS

FIG. 1 is a basic flowchart illustrating a method in accordance with an embodiment of the present invention;

FIG. 2 is a flowchart illustrating a method at block 101 in accordance with an embodiment of the present invention;

FIG. 3 is a schematic diagram illustrating data transmission in accordance with an embodiment of the present invention;

FIG. 4 is another schematic diagram illustrating data transmission in accordance with an embodiment of the present invention;

FIG. 5 is a schematic diagram illustrating a structure of a device in accordance with an embodiment of the present invention.

### DETAILED DESCRIPTION OF THE INVENTION

In order to make the object, technical solution and merits of the present invention clearer, the present invention will be illustrated in detail hereinafter with reference to the accompanying drawings and specific examples.

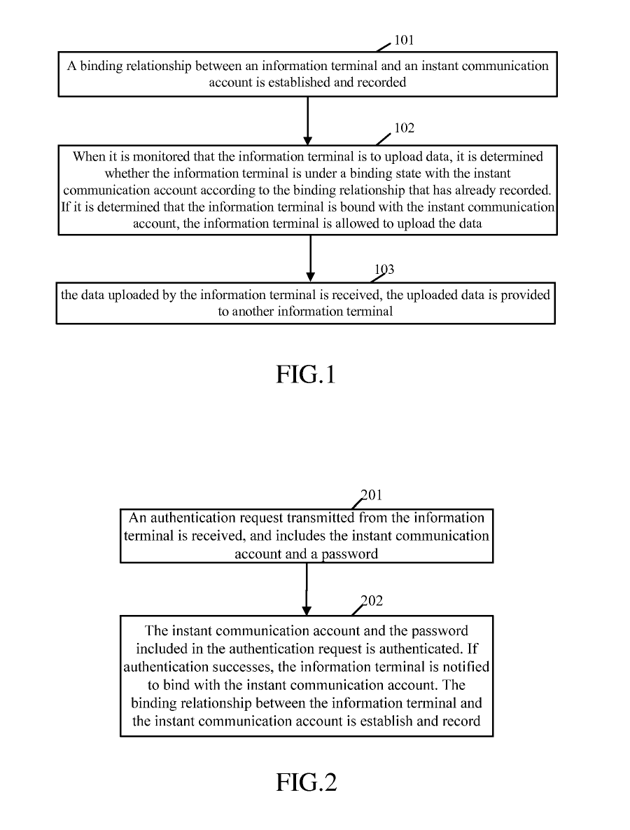

A process of a method provided in the present invention is shown in FIG. 1.

FIG. 1 is a basic flowchart illustrating a method in accordance with an embodiment of the present invention. As shown in FIG. 1, the process may include the following.

At block 101, a binding relationship between an information terminal and an instant messaging account is established and recorded.

At block 101, the instant messaging account may be a mail account, a Twitter account, a QQ number, which is not limited in the present invention.

The information terminal at block 101 may be a hardware device that may be used to input data such as images, characters, audios, videos and so on. The information terminal may be a mobile hardware device, such as a webcam, a recording pen, a phone, a camera and so on, and also may be a device that cannot be moved, which is not limited in the present invention.

FIG. 2 is a flowchart illustrating a method at block 101 in accordance with an embodiment of the present invention. As shown in FIG. 2, the process may include the following:

At block 201, an authentication request transmitted from the information terminal is received, which includes the instant messaging account and a password.

At block 201, communication is established with the information terminal, so that the authentication request transmitted from the information terminal can be received.

At block 202, the instant messaging account and the password included in the authentication request are authenticated. If authentication successes, the information terminal is notified to be bound with the instant messaging account. The binding relationship between the information terminal and the instant messaging account is established and recorded.

If the authentication does not success, it is not allowable to bind the information terminal with the instant messaging account.

The process as shown in FIG. 2 ends.

It should be noted that in the present invention, the information terminal bound with the instant messaging account may move and be updated. Moreover, an instant messaging account may be bound with multiple information terminals at the same time.

At block 102, when it is monitored that the information terminal is to upload data, it is determined whether the information terminal is under a binding state with the instant messaging account according to the binding relationship that has already recorded. If it is determined that the information terminal is bound with the instant messaging account, the information terminal is allowed to upload the data.

At block 102, communication is established with the information terminal. If a request of checking the binding state transmitted by the information terminal is received, the information terminal is to upload the data. That is, at block 102, when the request of checking the binding state transmitted from the information terminal is received, it is monitored that the information terminal is to upload the data. The data uploaded by the information terminal may be information inputted through the information terminal, such as images, characters, audios, videos and so on.

In addition, in the present invention, the binding relationship between the instant messaging account and the information terminal is not fixed, and may be updated according to a practical network requirement, e.g., a request of cancelling the binding relationship. When the instant messaging account has not a binding relationship with the information terminal, a record at block 101 is updated, i.e., the binding relationship is deleted from the record. In the present invention, the instant messaging is combined with the information terminal. Only when the information terminal is bound with the instant messaging account, the information terminal is allowed to upload the data. Based on this, when it is monitored that the information terminal is to upload the data, it is determined whether the information terminal is currently under the binding state with an instant messaging account according to the binding relationship that has already been recorded. If it is determined that the information terminal is currently under the binding state with an instant messaging account, the information terminal is allowed to upload the data. If it is determined that the information terminal currently is not under the binding state with an instant messaging account, the information terminal is prevented to upload the data.

Preferably, in the present invention, determining whether the information terminal currently is under the binding state with an instant messaging account according to the binding relationship recorded includes: searching the binding relationship recorded for the binding relationship between the information terminal and the instant messaging account, determining that the information terminal is currently under the binding state with an instant messaging account if the binding relationship between the information terminal and the instant messaging account is searched out, determining that the information terminal currently is not under the binding state with an instant messaging account if the binding relationship between the information terminal and the instant messaging account is not searched out.

At block 103, the data uploaded by the information terminal is received, the uploaded data is provided to another information terminal.

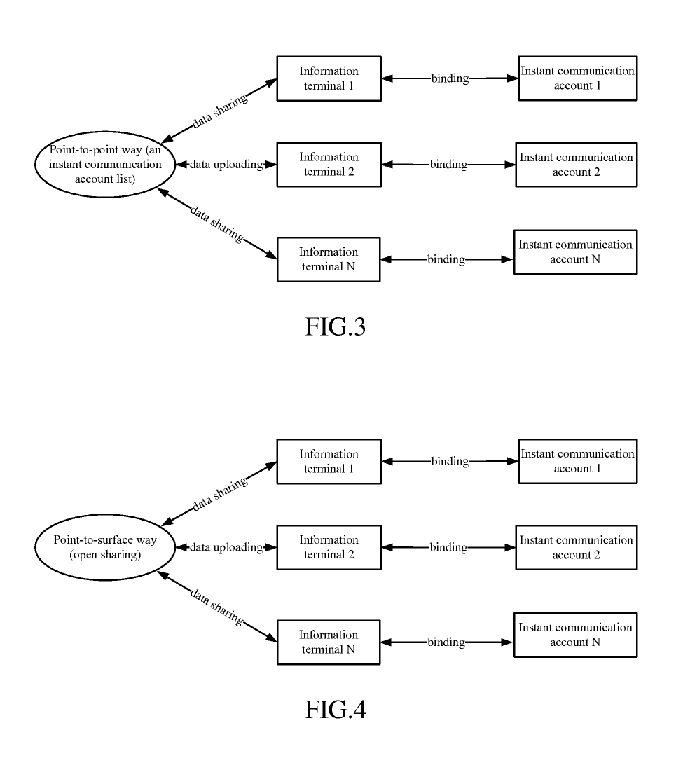

At block 103, the uploaded data may be provided to another information terminal in two ways. One way is through an individual-to-individual transmission. The other way is through an individual-to-organization transmission.

Wherein, the process of providing the uploaded data to another information terminal through an individual-to-individual transmission may include:
acquiring an instant messaging account list carried in the uploaded data;
determining the information terminal bound to each instant messaging account in the instant messaging account list, establishing a connection with information terminal determined, transmitting the uploaded data via the connection, as shown in FIG. 3.

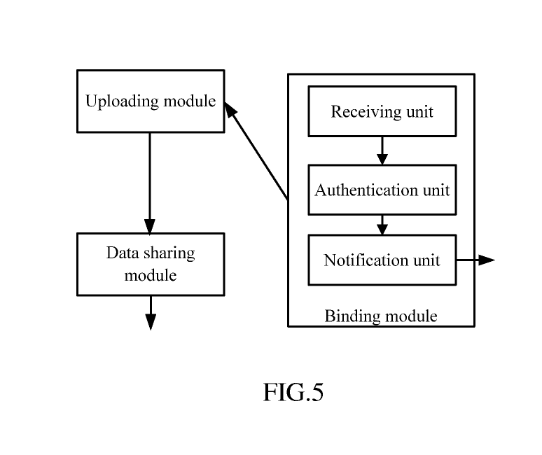

While, the process of providing the uploaded data to another information terminal through an individual-to-organization transmission may include:
setting an open sharing permission for the uploaded data, so that an information terminal bound to any instant messaging account may acquire the uploaded data, as shown in FIG. 4.

In the present invention, by providing the data through the individual-to-individual or the individual-to-organization transmission, ways of acquiring information can be added.

It should be noted that another information terminal to which the data uploaded by the information terminal bounded with the instant messaging account is provided may be: an information terminal bound with a friend in a friend list of the instant messaging account, or an information terminal bound with an instant messaging account not associated with the instant messaging account.

The process as shown in FIG. 1 ends.

It should be noted that a server in Social Networking Service (SNS) Platform may implement blocks 101 to 103 in the process as shown in FIG. 1.

A method provided in the present invention is described above. A device provided by the present invention is described as follows.

FIG. 5 is a schematic diagram illustrating a structure of a device in accordance with an embodiment of the present invention. The device includes:
a binding module, to establish and record a binding relationship between an information terminal and an instant messaging account;
an uploading module, to determine whether the information terminal is currently under a binding state with the instant messaging account according to the blinding relationship recorded when it is monitored that the information terminal is to upload data, allow the information terminal to upload the data if it is determined that the information terminal is under the binding state with the instant messaging account;
a data sharing module, to receive the data uploaded by the information terminal, provide the uploaded data to another information terminal.

Preferably, as shown in FIG. 5, the binding module includes:
a receiving unit, to receive an authentication request transmitted from the information terminal, wherein the authentication request comprises the instant messaging account and a password;
an authentication unit, to perform authentication for the instant messaging account and the password in the authentication request;
a notification unit, to notify the information terminal to be bound with the instant messaging account, establish and record the binding relationship between the information terminal and the instant messaging account if the authentication successes.

Preferably, in the present invention, the data sharing module is to provide the uploaded data to another information terminal through an individual-to-individual transmission or an individual-to-organization transmission.

The data sharing module provides the uploaded data to another information terminal through an individual-to-individual transmission by:
acquiring an instant messaging account list carried in the uploaded data;
determining an information terminal bound with each instant messaging account in the instant messaging account list, establishing a connection with the information terminal determined, transmitting the uploaded data via the connection.

The data sharing module provides the uploaded data to another information terminal through an individual-to-organization transmission by:
setting an open sharing permission for the uploaded data, so that an information terminal bound with any instant messaging account may acquire the uploaded data.

Description of the device provided in the present invention ends.

It can be seen from the above technical solution that, in the present invention, the instant messaging account is bound with the information terminal. The data uploaded by the information terminal bound with the instant messaging account is received. And the uploaded data is provided to another information terminal, so as to implement interconnection and interworking between the information terminal and the instant messaging application. Furthermore, in the present invention, since the instant messaging account is bounded with the information terminal, another instant messaging account can achieve information interacting with the information terminal through the instant messaging account bounded with the information terminal so as to enhance the information interacting.

Furthermore, in the present invention, by providing the data through the individual-to-individual or the individual-to-organization transmission, ways of acquiring information can be added. Moreover, in the present invention, since the instant messaging account is bounded with the information terminal, another instant messaging account can achieve information interacting with the information terminal through the instant messaging account bounded with the information terminal so as to enhance the information interacting.

Furthermore, in the present invention, the information terminal bound with the instant messaging account may be mobile and updated. Thus, it is implemented that the information terminal can be selected and updated. Moreover, only when an instant messaging account is fixed, the instant messaging account may be bound with multiple information terminals at the same time to instantly acquire data in each information terminal bounded with the instant messaging account.

The foregoing is only preferred examples of the present invention and is not used to limit the protection scope of the present invention. Any modification, equivalent substitution and improvement without departing from the spirit and principle of the present invention are within the protection scope of the present invention.

1. An information processing method in instant messaging, comprising:
establishing and recording a binding relationship between a first information terminal and an instant messaging account;
determining whether the first information terminal is under a binding state with the instant messaging account according to the blinding relationship recorded when monitoring that the first information terminal is to upload data, allowing the first information terminal to upload the data if it is determined that the first information terminal is under the binding state with the instant messaging account;
receiving the data uploaded by the first information terminal, providing the uploaded data to a second information terminal.

2. The method of claim 1, wherein establishing and recording a binding relationship between a first information terminal and an instant messaging account comprises:
receiving an authentication request transmitted from the first information terminal, wherein the authentication request comprises the instant messaging account and a password;
performing authentication for the instant messaging account and the password in the authentication request, if the authentication successes, notifying the first information terminal to be bound with the instant messaging account, establishing and recording the binding relationship between the first information terminal and the instant messaging account.

3. The method of claim 1, wherein providing the uploaded data to a second information terminal comprises:
providing the uploaded data to the second information terminal through an individual-to-individual transmission or an individual-to-organization transmission.

4. The method of claim 3, wherein providing the uploaded data to a second information terminal through an individual-to-individual transmission comprises:
acquiring an instant messaging account list carried in the uploaded data;
determining the second information terminal bound with each instant messaging account in the instant messaging account list,
establishing a connection with the second information terminal determined, and
transmitting the uploaded data via the connection.

5. The method of claim 3, wherein providing the uploaded data to a second information terminal through an individual-to-organization transmission comprises:
setting an open sharing permission for the uploaded data to make the second information terminal bound with any instant messaging account be able to acquire the uploaded data.

6. An information processing device in instant messaging, comprising:
a binding module, to establish and record a binding relationship between a first information terminal and an instant messaging account;
an uploading module, to determine whether the first information terminal is under a binding state with the instant messaging account according to the blinding relationship recorded when it is monitored that the first information terminal is to upload data, allow the first information terminal to upload the data if it is determined that the first information terminal is under the binding state with the instant messaging account;
a data sharing module, to receive the data uploaded by the first information terminal, provide the uploaded data to a second information terminal.

7. The device of claim 6, wherein the binding module comprises:
a receiving unit, to receive an authentication request transmitted from the first information terminal, wherein the authentication request comprises the instant messaging account and a password;
an authentication unit, to perform authentication for the instant messaging account and the password in the authentication request;
a notification unit, to notify the first information terminal to be bound with the instant messaging account, establish and record the binding relationship between the first information terminal and the instant messaging account if the authentication successes.

8. The method of claim 6, wherein the data sharing module is to provide the uploaded data to the second information terminal through an individual-to-individual transmission or an individual-to-organization transmission.

9. The method of claim 8, wherein the data sharing module provides the uploaded data to the second information terminal through an individual-to-individual transmission by
acquiring an instant messaging account list carried in the uploaded data;
determining the second information terminal bound with each instant messaging account in the instant messaging account list, establishing a connection with the second information terminal determined, transmitting the uploaded data via the connection.

10. The method of claim 8, wherein the data sharing module provides the uploaded data to the second information terminal through an individual-to-organization transmission by
setting an open sharing permission for the uploaded data to make the second information terminal bound with any instant messaging account be able to acquire the uploaded data.
